(19) United States
(12) Patent Application Publication
(10) Pub. No.: US 2006/0239196 A1
(43) Pub. Date: Oct. 26, 2006

(54) System and method for performing load balancing across a plurality of servers

(76) Inventors: Sanjay Khanna, Cary, NC (US); Peter Denz, Cary, NC (US); Daniel Schudel, Durham, NC (US)

Correspondence Address: ERICSSON INC., 6300 LEGACY DRIVE, M/S EVR C11, PLANO, TX, 75024, US

(21) Appl. No.: 11/114,596

(22) Filed: Apr. 25, 2005

(51) Int. Cl. H04J 1/16; H04L 12/56

(52) U.S. Cl. 370/235; 370/392

(57) ABSTRACT

Various systems and method are disclosed for selecting a destination server from a plurality of servers, the method comprising: receiving an incoming packet; identifying a stream of bits from within the incoming packet; calculating a signature from the identified stream of bits; mapping the incoming packet to the destination server using the signature; updating the statistics for the destination server, and forwarding the incoming packet to the destination server.

### TECHNICAL FIELD

This invention relates in general to network systems, and in particular to systems and methods for load balancing among servers in a network environment.

### BACKGROUND INFORMATION

The number of users accessing the Internet is growing exponentially which presents new challenges for service providers to reduce response times by developing new ways to distribute the increasing load. One such way to distribute the load is to use multiple servers located throughout the world.

In a typical client-server application model, clients send requests to servers and get responses from servers. In many situations, these requests travel over an IP network inside an IP packet. To increase the capacity and response time, one common technique is to employ multiple servers to serve the clients. The client requests can be distributed among the available servers using various methods. One such method is to use a Domain Name Server (“DNS”) server to map the name of the server to a different IP address in a round robin fashion.

DNS servers are special servers that include a look-up table for storing the host name and unique IP addresses of multiple alternative servers located within the entire network (or in a local region if the network is the Internet). Typically, DNS servers also store the host names and IP addresses for all of the plurality of alternative servers. The DNS server round robin technique is rudimentary. Furthermore, each server has a different IP address. So, the scheme fails to work properly if clients do not use name lookups and use IP addresses directly to reach the servers or, more commonly, fails due to DNS caching by hosts and intermediate DNS servers.

Another commonly employed technique is to modify the server implementation such that the servers act as a one big machine and pass client requests around using some proprietary logic. The modified server implementations, on the other hand, add complicated logic on the server side and the resulting implementation is non-portable and may not be compliant with client-server protocol standards.

Yet, another method for distributing requests to a plurality of servers is to add a network device (or an enhanced router) to the network right before or adjacent to the servers so that every incoming IP packet passes through this device. The device has special logic to inspect all incoming IP packets and then assign some of these packets to a server. This device remembers state for every such client-server association which complicates the logic and slows down the forwarding of packets. Note that for purposes of this application, an “association” may be defined as an IP session between a client and server. This session may be connection oriented or connectionless. This session may be long lived or short lived. During the life of a session, request and responses flow between the client and the server. Furthermore, a client may have more than one association going on at any time. Such a device can also use methods documented in the RFC2991. In addition to slow performance, such methods only work on the well known fields of the IP, TCP and UDP headers of an incoming packet.

What is needed, therefore, is a simple and fast system and method to implement load balancing among a plurality of alternative servers.

### SUMMARY

In response to these and other problems, there is disclosed a method for selecting a destination server from a plurality of servers, the method comprises: setting up the servers, receiving an incoming packet; identifying a stream of bits from within the incoming packet; calculating a signature from the identified stream of bits; mapping the incoming packet to the destination server using the signature; updating the statistics for the destination server, and forwarding the incoming packet to the destination server.

In another aspect of the invention, the identifying step further comprises: classifying incoming packets to determine if load balancing is required, if load balancing is required, receiving an identifier that uniquely identifies a template rule.

In another aspect of the invention, the calculating step further comprises: locating the template rule using the identifier; identifying bits in the packet according to the template rule; building a bit string from the identified bits; processing the bit string to generate a signature number.

In another aspect of the invention, the signature number is summation of a byte-by-byte addition of the bit-string.

In another aspect of the invention, the calculating step further comprises: locating the template rule using the identifier; identifying which bits in the packet should be used in calculating a signature from a set of tuples associated with the template rule; building a bit string from the incoming packet according to the bits identified from the set of tuples; and processing the bit string to generate a signature number.

In another aspect of the invention, the mapping step further comprises: locating a server index using the signature; and locating forwarding information for a destination server using the server index.

In another aspect, the above method may also include generating the server index with a modulo-n operation, where n is the number of servers.

In another aspect, the above method may also include: configuring a load balancing template rule (“LBTR”); adding the configured load balancing template rule to an LBTR table; and assigning the load balancing template rule to a rule identifier.

In another aspect there is disclosed a network node comprising: a communications interface for communicating with a network; a second communications interface for communicating with a plurality of servers, a processor for selecting a destination server from the plurality of servers, a memory, wherein the memory has instructions for selecting a destination server from a plurality of servers, the instructions comprising: receiving an incoming packet; identifying a stream of bits from within the incoming packet; calculating a signature from the identified stream of bits; mapping the incoming packet to the destination server using the signature; updating the statistics for the destination server, and forwarding the incoming packet to the destination server.

In some aspects of the above network node, the identifying instruction further comprises: classifying incoming packets to determine if load balancing is required; and if load balancing is required, receiving an identifier that uniquely identifies a template rule.

In some aspects of the above network node, the calculating instruction further comprises: locating the template rule using the identifier; identifying bits in the incoming packet according to the template rule; building a bit string from the identified bits; and processing the bit string to generate a signature number.

In some aspects of the above network node, the calculating instruction further comprises: locating the template rule using the identifier; identifying which bits in the packet should be used in calculating a signature from a set of tuples associated with the template rule; building a bit string from the incoming packet according to the bits identified from the set of tuples; and processing the bit string to generate a signature number.

In some aspects of the above network node, the mapping instruction further comprises: locating a server index using the signature number; and locating forwarding information for a destination server.

In some aspects of the above network node, the instructions further comprise generating the server index with a modulo-n operation, where n is the number of servers.

In some aspects of the above network node, the instructions further define an external control load balancing agent for setup, control and management of a load balancing process.

In some aspects of the above network node, the external control load balancing agent defines a set of rules to identify the bits in a packet.

In some aspects of the above network node, the external control load balancing agent define rules, where the rules are selected from the group consisting of: template rules for identify tuples, rules for establishing mapping algorithms and rules for identifying server information objects.

In some aspects of the above network node, the external control load balancing agent comprises instructions for changing the number of servers in a given template.

In some aspects of the above network node, the instructions further comprise: configuring a load balancing template rule (“LBTR”); adding the configured load balancing template rule to a LBTR table; and assigning the load balancing template rule to a rule identifier.

Certain aspects of the present invention uses a non-traditional form of multi-field packet classification in which various fields of the packet headers are identified that will be key to server determination. This load balancing scheme can be implemented with only a small amount of code which is inserted into the packet processing and forwarding logic on a network device (such as router) to perform the classification and server assignment. Thus, such a system does not impact the overall performance of the packet forwarding. Furthermore, certain aspects of the present invention are not dependent on tracking the state of the servers, which also results in faster performance.

These and other features, and advantages, will be more clearly understood from the following detailed description taken in conjunction with the accompanying drawings. It is important to note the drawings are not intended to represent the only aspect of the invention.

### BRIEF DESCRIPTION OF THE DRAWINGS

FIG. 1 is a schematic diagram of a system which may employ one or more aspects of the present invention.

FIG. 2 is a process flow diagram of a process which may employ one or more aspects of the present invention.

FIG. 3 is a detailed process flow diagram of one of the sub-processes illustrated in FIG. 2.

FIG. 4 is a detailed process flow diagram of one of the sub-processes illustrated in FIG. 2.

### DETAILED DESCRIPTION

Specific examples of components, signals, messages, protocols, and arrangements are described below to simplify the present disclosure. These are, of course, merely examples and are not intended to limit the invention from that described in the claims. Well-known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art. Details regarding control circuitry are omitted, as such control circuits are within the skills of persons of ordinary skill in the relevant art.

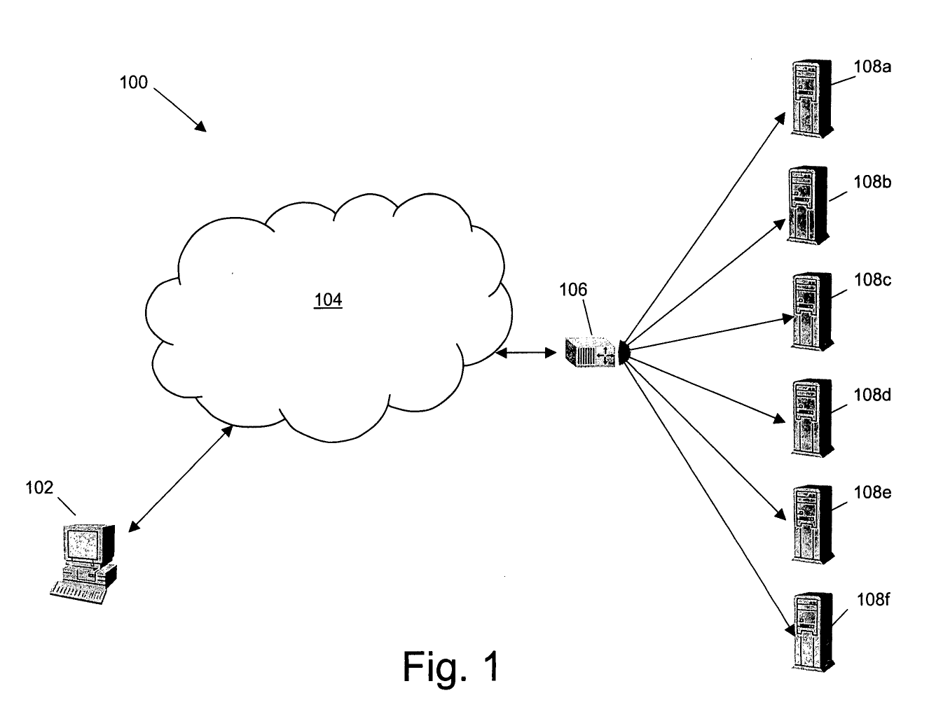

Turning now to FIG. 1, there is presented a system 100 which may employ one or more aspects of the present invention. As illustrated, a client 102 may be in communication with an IP network 104, such as the Internet. A network device 106, such as an intelligent peripheral interface, may also be in communication with the network 104. The network device 106 may also be in communication with a plurality of alternative servers 108a through 108f. The client 102 transmits a request to a server. The system can then operate to select an appropriate server from a plurality of servers 108a through 108f providing the same service (e.g., alternative servers) where each is assigned to a common host name and a unique Internet Protocol address. The request (in the form of a one or more packets) travel through the network device 106. The network device 106 then selects which server to respond to the request. Responses from the selected server pass through the network device 106 and get forwarded in a conventional manner towards the client over the network 104.

In some aspects of the invention, the network device 106 performs processes for achieving load balancing across the servers 108a through 108f. The process does not use filters. Instead certain aspects of the present invention identify bit patterns using a predetermined load balancing template.

In certain embodiments, the network device 106 may be a similar to a router except that the network device has IP classification and IP forwarding functions. Routers utilize the IP protocol to connect the respective user networks to the Internet and other networks. Each router may contain a routing table for storing routes derived from network topology information exchanged between the routers within the network 104. The routes are saved in the router's forwarding memory and are typically referred to as a forwarding information base (FIB).

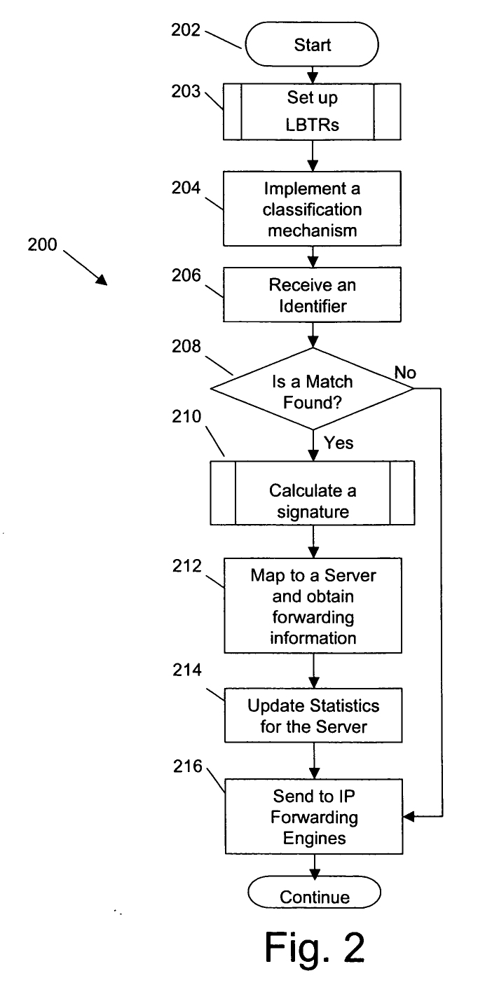

FIG. 2 illustrates a method 200 which implements one or more aspects of the present invention. The process starts at step 202 and continues to step 203 where load balancing template rules (“LBTRs”) are configured. In some aspects, the LBTRs are stored in the forwarding memory of the network device 106 as a table. In certain embodiments, an index may be used to lookup the LBTR. Each LBTR identifies a different group of servers providing differing services. So, this network device 106 may actually be used to load balance more than one set of servers.

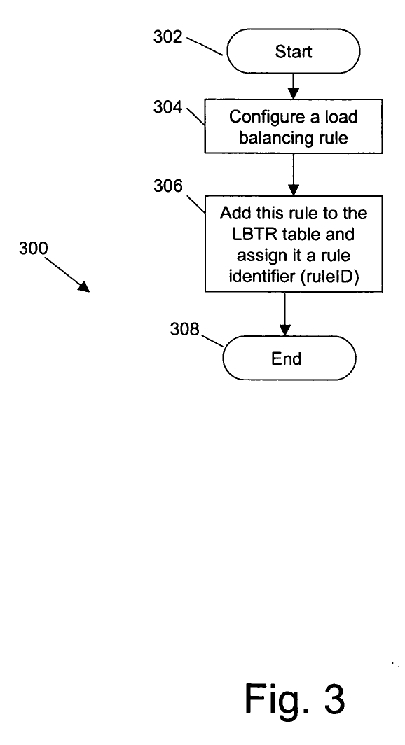

Turning now to FIG. 3, there is one embodiment of a sub-process which may be used to configure the load balancing rules. The process starts in step 302 and continues to step 304 where a load balancing rule may be configured. Thus, in step 306, the configured rule may then be added to a LBTR table and assigned a rule identifier (ruleID). The process 300 then ends and control may be returned to the process 200.

In some embodiments, the LBTR table (e.g., TemplateRuleList) may be stored in the forwarding memory of the network device 106. This table may contain a list of LBTRs (load balancing template rules). Each LBTR has a set of tuples. A tuple is a collection of an arbitrary but fixed number of elements, each being of arbitrary, but fixed type. As will be explained later, these tuples are used in building a bit-stream from the IP packet. An LBTR may also have a count of number of servers. Server specific information may also be tracked, such as feedback information, IP address and counters. The feedback information may be statistics such as the number of bytes, throughput etc. This information may be used for controlling in-service performance of the network device 106. The LBTR may also have an algorithm that is specific to the load balancing needs of the servers.

In one example embodiment, the following structure may be used for a load balancing template rule:

```
Struct templateRule {
    Int howmany_tuples;
    Struct tuple {
        Int offset_from_start_of_packet_in_bits;
        Int length_of_bits;
    } tupleList [ ]; /* also serves as template-rule */
    Algorithm SignatureCalculationAlgorithm;
    Int howmany_servers;
    Struct ServerInfo {
        Feedback Information;
        IPAddress Server;
        Counters ServerC;
    } ServerList [ ];
    Algorithm DistributionAlgorithm;
} TemplateRuleList [ ];
```

Turning back to FIG. 2, and continuing to step 204 where, in some embodiments, a conventional classification system may be employed. This conventional multi-field packet classification system typically involves specification of value/mask filters, specified in order of increasing precedence, based upon various fields of the packet headers. Upon arrival of a packet the filters are checked for conformance—typically through a specialized search algorithm, or, when available, using Content Addressable Memory for a hardware-assisted search. The process classifies incoming packets to determine if the forwarding action is load balancing. Any degree of conventional classification rules may be applied to arrive at this decision. In certain embodiments, the classification system returns an action which describes the treatment that the matching packet class is to undergo, such as dropping, remarking, routing, or in this case, selecting a load balance template rule.

In step 206, the process implements a new action which returns an identifier (ruleID) that uniquely identifies a Load-balancing-Template-Rule (“LBTR”). In step 208, the process determines whether there is a match between the received identifier and a LBTR. If a match is found, the process flows to step 210. On the other hand, if a match is not found, the process flows to step 216.

For example, assume a packet arrives conforming to User Datagram Protocol (“UDP”). Further assume that the Destination Port (“DSTP”) field of the UDP packet has a value of 53, on input router Port=1. The classification rules will match the UDP port and ingress router port and the packet would be assigned a ruleID. In the LBTR table, LBTR[ruleID] will point to the LBTR for load-balancing the packets arriving for service matching this destination port.

As another example, assume a Transmission Control Protocol (“TCP”) packet arrives having a DSTP field of 80 arriving on router Port-1 the classification rules would match the packet and then the packet would be assigned with a different ruleID.

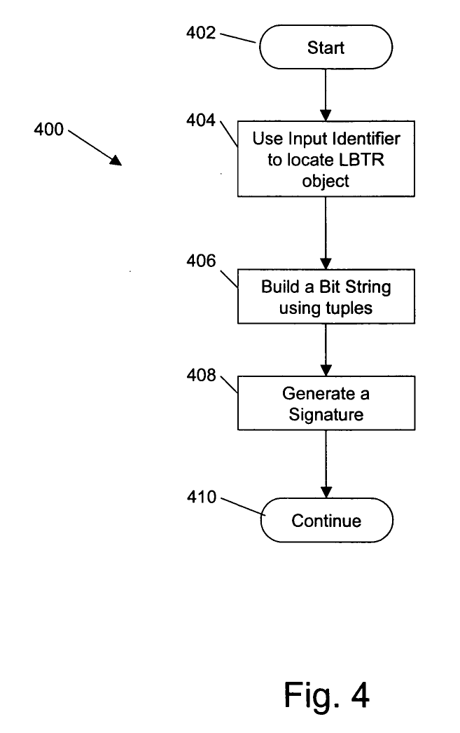

In step 210, using the input identifier (ruleID), a LBTR object may be located in the LBTR table in the forwarding memory and a signature may be calculated. FIG. 4 illustrates a sub-process 400 showing one embodiment of a signature calculation process. For purposes of this explanation, the sub-process begins at step 402 and continues to step 404 where the input identifier is used to locate the LBTR object. In some embodiments, a template may be used to build a bit stream from the packet, which, as will be explained later, identifies a client-server association. An exemplary template, which consists of the specification of various fields in the packet headers, may be modeled as:

```
Struct template {
    Int howmany_tuples;
    Struct tuple {
        Int offset_from_start_of_packet_in_bits;
        Int length_of_bits;
    } *t;
} T;
```

In certain embodiments, the LBTR object may have a set of tuples that identify which bits in the packet should be used in calculating the signature. These tuples may be offset in number of bits from start of packet. In some embodiments, there may be more than one tuple in a set. In some embodiments, this template specifies bit ranges for the various fields in the packet, not actual values for these fields as is done in traditional filter specification. Thus, certain aspects of the present invention do not require the use of filters. Rather than using filters, certain aspects involve identifying bit patterns using a given load balancing template.

Using these tuples one by one and the incoming packet, a bit string may be built (step 406). This bit string may then used to calculate a signature in step 408. In some embodiments, the LBTR object may also have an algorithm associated with it which takes this bit-stream as the input. This algorithm processes the bit stream to generate a number. This number may be used as a signature to identify a particular destination server (in other words, the signature may be used to map the packet to a particular destination server). The signature may be calculated by a number of different methods, but should not be computationally intensive. For instance, in one embodiment, the signature may be calculated to be the final summation of a byte-by-byte addition of the bit-string.

Certain aspects of the present invention assume that the incoming packets are not IP fragmented. Because tuples can be specified across the entire packet, the fragments will make it harder to map them to the same server.

In some embodiments, this signature may always be same for all the packets that identify the session going to a server. This calculation may be performed in such a way that successive packets belonging to the same client-server association are all mapped to the same server. The servers are also assigned uniformly over all of the associations, thus achieving the desired load balancing in the system.

The sub-process then flows to step 410 which returns to the main process 200. Turning back to FIG. 2, the process then flows to step 212 where the packet may be mapped to a destination server using the calculated signature. In some embodiments, the LBTR object may have a mapping algorithm associated with it. The LBTR object may also have references to a plurality of servers, such as servers 108a through 108f. The LBTR object may also contain information relating to each server, for instance, the IP address of the server, IP forwarding related information and statistics. In some embodiments, the mapping step or algorithm uses the signature as the input and then generates a server index. The server index is a number that can be used to index in the LBTR table of servers. The server index may then be used to locate forwarding information associated with the server index. Furthermore, feedback about server load can be used as a factor in server selection. The feedback data is collected in terms of (but not limited to) number of bytes sent by the server, throughput in bps per server, connections per second. Using the operational, administration and maintenance interface, this feedback can be given to a control process running on the node. This control process can alarm the operator to increase the capacity in case of server failures, and/or server over-subscription.

For example, the server index may be generated with a modulo-n operation where n is the number of active servers maintained in the LBTR. For every server in the LBTR, it will have layer 2 information. Layer 2 information is layer 2 technology specific and for Ethernet it may include MAC address of the selected server, VLAN ID, link towards the server and MTU of the link. The layer 2 information may then be used by conventional IP Forwarding engines to forward the packet.

At step 214, the server information objects are located inside the LBTR based on the server index so that the statistics may be updated and forwarding information be obtained for that server. For example, the updated information may include such statistics as the packet count and byte counts.

In step 216, the IP packet is then sent to IP forwarding engines. For purposes of this application, an IP forwarding engine may be any existing IP forwarding implementation used by a router that takes an IP packet and then forwards it to the next hop router in the IP network. Such an implementation may use a conventional forwarding information base (“FIB”) as input to forward IP packets by doing a route lookup on the IP destination. If there is no forwarding information already present, then a conventional IP forwarding process is implemented after the route lookup process is performed. On the other hand, if there is forwarding information available from step 214, then the conventional IP forwarding is not used. Instead, the packet is forwarded based on the forwarding information. Thus, the packet is forwarded towards the IP destination referenced in the forwarding information.

As an example, if the fields for classification of http traffic include the IPSA, IPDA, IP Protocol, SRCP, and DSTP fields, the corresponding template would be similar to:

Struct tuple http[2]={{72, 8}, {96, 96}}
Struct template web={2, http}
The concatenation of these fields yields a 13 byte signature which is used in the server determination. The calculation of the server identifier; which is a number in the range of [0 . . . n−1], where n is the number of available servers; from the signature involves summing each of the 13 bytes of the signature into a 32 bit accumulator, and taking this result modulo n. Through simulation experiments, this load balancing distribution was found to be very close to a uniform distribution across the servers.

Running in conjunction with the process 200 may be an external control load balancing agent which is responsible for the setup, control and management of the load balancing performed in steps 204 through 216. Such an external control load balancing agent may define a set of rules needed to identify a stream in step 208. The agent may also define the information needed to build the LBTR—tuple rules, mapping algorithms and server-info-objects. In certain embodiments, the agent may also provide a mechanism to change the number of servers in a given LBTR. Such mechanisms can be manual or automatic.

The abstract of the disclosure is provided for the sole reason of complying with the rules requiring an abstract, which will allow a searcher to quickly ascertain the subject matter of the technical disclosure of any patent issued from this disclosure. It is submitted with the understanding that it will not be used to interpret or limit the scope or meaning of the claims.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

For example, the method discussed above could be implemented in a router, having a network node comprising: a communications interface for communicating with a network; a second communications interface for communicating with a plurality of servers, a processor for selecting a destination server from the plurality of servers, a memory. The memory may have instructions for identifying a stream from an incoming packet, calculating a signature, mapping to a server, updating statistics for the server, and forwarding the packet to the destination server.

In such an embodiment, the stream identification classifies incoming packets to decide if load balancing is required and associates an identifier to the packet. The identifier may be used to associate a template rule to the packet so that a signature may be calculated for the packet. The signature can then be used to find a server index. The server index may be used to locate forwarding information associated with the server index. Statistics for the destination server can then be updated and the packet forwarded to the destination server. One skilled in the art would recognize that other embodiments are also possible and are included in the scope of the claims.

What is claimed is:

1. A method for selecting a destination server from a plurality of servers, the method comprising:
receiving an incoming packet;
identifying a stream of bits from within the incoming packet;
calculating a signature from the identified stream of bits;
mapping the incoming packet to the destination server using the signature;
updating the statistics for the destination server, and
forwarding the incoming packet to the destination server.

2. The method of claim 1, wherein the identifying further comprises:
classifying incoming packets to determine if load balancing is required,
if load balancing is required, receiving an identifier that uniquely identifies a template rule.

3. The method of claim 2, wherein the calculating further comprises:
locating the template rule using the identifier;
identifying bits in the packet according to the template rule;
building a bit string from the identified bits;
processing the bit string to generate a signature number.

4. The method of claim 3, wherein the signature number is summation of a byte-by-byte addition of the bit-string.

5. The method of claim 2, wherein the calculating further comprises:
locating the template rule using the identifier;
identifying which bits in the packet should be used in calculating a signature from a set of tuples associated with the template rule;
building a bit string from the incoming packet according to the bits identified from the set of tuples; and
processing the bit string to generate a signature number.

6. The method of claim 2, wherein the mapping further comprises:
locating a server index using the signature; and
locating forwarding information for a destination server using the server index.

7. The method of claim 6, further comprising generating the server index with a modulo-n operation, where n is the number of servers.

8. The method of claim 1, further comprising:
configuring a load balancing template rule (“LBTR”);
adding the configured load balancing template rule to an LBTR table; and
assigning the load balancing template rule to a rule identifier.

9. A network node comprising:
a first communications interface for communicating with a network;
a second communications interface for communicating with a plurality of servers,
a processor in communication with the first and second communications interface for selecting a destination server from the plurality of servers,
a memory coupled to the processor, wherein the memory has instructions for selecting a destination server from a plurality of servers, the instructions comprising:
receiving an incoming packet;
identifying a stream of bits from within the incoming packet;
calculating a signature from the identified stream of bits;
mapping the incoming packet to the destination server using the signature;
updating the statistics for the destination server, and
forwarding the incoming packet to the destination server.

10. The network node of claim 9, wherein the identifying instruction further comprises:
classifying incoming packets to determine if load balancing is required; and
if load balancing is required, receiving an identifier that uniquely identifies a template rule.

11. The network node of claim 10, wherein the calculating instruction further comprises:
locating the template rule using the identifier;
identifying bits in the incoming packet according to the template rule;
building a bit string from the identified bits; and
processing the bit string to generate a signature number.

12. The network node of claim 10, wherein the calculating instruction further comprises:
locating the template rule using the identifier;
identifying which bits in the packet should be used in calculating a signature from a set of tuples associated with the template rule;
building a bit string from the incoming packet according to the bits identified from the set of tuples; and
processing the bit string to generate a signature number.

13. The network node of claim 10, wherein the mapping instruction further comprises:
locating a server index using the signature number; and
locating forwarding information for a destination server.

14. The network node of claim 10, wherein the instructions further comprise generating the server index with a modulo-n operation, where n is the number of servers.

15. The network node of claim 10, wherein the instructions further define an external control load balancing agent for setup, control and management of a load balancing process.

16. The network node of claim 15, wherein the external control load balancing agent defines a set of rules to identify the bits in a packet.

17. The network node of claim 15, wherein the external control load balancing agent define rules, where the rules are selected from the group consisting of: template rules for identify tuples, rules for establishing mapping algorithms and rules for identifying server information objects.

18. The network node of claim 15, wherein the external control load balancing agent comprises instructions for changing the number of servers in a given template.

19. The network node of claim 10, wherein the instructions further comprise:
configuring a load balancing template rule (“LBTR”);
adding the configured load balancing template rule to a LBTR table; and
assigning the load balancing template rule to a rule identifier.

20. A method for selecting a destination server from a plurality of servers, the method comprising:
receiving an incoming packet;
classifying the incoming packet to determine if load balancing is required, if load balancing is required, then locating an identifier for the packet
locating a template rule using the identifier;
calculating a signature using the template rule, wherein the calculating further comprises:
identifying bits in the packet according to the template rule,
building a bit string from the identified bits,
processing the bit string to generate a signature number,
locating the template rule using the identifier,
identifying which bits in the packet should be used in calculating a signature from a set of tuples associated with the template rule,
building a bit string from the incoming packet according to the bits identified from the set of tuples, and
processing the bit string to generate a signature number;
mapping the incoming packet to the destination server using the signature;
updating the statistics for the destination server; and
forwarding the incoming packet to the destination server.
